(19) United States
(12) Patent Application Publication
(10) Pub. No.: US 2004/0090572 A1
(43) Pub. Date: May 13, 2004

(54) Prism sheet and fabrication method thereof and liquid crystal display device employing the same

(76) Inventors: Byung-Woong Han, Incheon-si (KR); Jong-Dae Park, Seoul (KR); Jeong-Hwan Lee, Gyeonggi-do (KR)

Correspondence Address: CANTOR COLBURN LLP, 55 Griffin Road South, Bloomfield, CT, 06002, US

(21) Appl. No.: 10/679,771

(22) Filed: Oct. 6, 2003

(30) Foreign Application Priority Data
Nov. 11, 2002 (KR) 2002-69777
Jun. 23, 2003 (KR) 2003-40550

(51) Int. Cl. G02F 1/1335

(52) U.S. Cl. 349/95

(57) ABSTRACT

A prism sheet includes a light incident surface for receiving the light, a light emission surface for emitting the light incident on the light incident surface, which includes at least one light concentrate unit having at least two inclined surfaces on which the light is incident and refracted. A peak angle between the two inclined surfaces is obtuse and determined in association with a refraction index of the prism sheet. The light emission surface has multiple light concentrate units that each have a shape of a prism column and are arranged parallel with each other in a longitudinal direction of the light concentrate units. A liquid crystal display device includes the prism sheet, a lamp assembly for generating light, a diffusion plate for diffusing the light, and a LCD panel assembly for displaying images using the light from the prism sheet and image data externally provided.

### BACKGROUND OF THE INVENTION

1. Field of the Invention

The present invention relates to an optical sheet and an image display device, and more particularly, to a prism sheet designed to improve luminance and viewing angle of a display device and a method of fabricating the prism sheet, and a liquid crystal display device employing the same.

2. Description of the Related Art

Image display devices such as liquid crystal display (LCD) devices basically have a light assembly for providing light, a display assembly for processing image data and displaying images thereon, and various types of optical means for converting the light from the light assembly into light more appropriate for the display assembly. Such optical means generally include a light guide plate that guides the light from the light assembly to provide the display assembly with light having uniform distribution, and one or more optical sheets that enhance the luminance at the display assembly by adjusting paths of the light provided from the light assembly through the light guide plate.

Of the optical sheets, a prism sheet is generally employed in an LCD device to enhance the luminance, especially the front luminance, at its display panel to display quality images. Since the light exiting the light guide plate is diffused therein, a wide viewing angle and low luminance may be measured at the display panel when displaying images using the diffused light. Thus, LCD devices employ a prism sheet for concentrating the diffused light to travel toward the display panel so as to improve the front luminance at the display panel. An example of such prism sheet is described in U.S. Pat. No. 6,354,709 for Optical Film issued to Campbell et. al., where disclosed is an optical sheet for concentrating light incident thereon and preventing moire phenomenon caused by interference between pixel patterns of an LCD panel.

The structure and functions of a conventional prism sheet is described below with reference to the relating drawings.

FIG. 1 is a perspective view of a conventional prism sheet. The prism sheet 100 in FIG. 1 has a light incident surface 110, a light emission surface 120, and side surfaces 130. Light supplied from an external light source is incident onto the light incident surface 110, and the light exits the light emission surface 120. The light emission surface 120 is formed with multiple light concentrate units 116 each having a prism shape. The light concentrate units 116 are elongated in a selected direction and aligned parallel with each other. Each of the light concentrate units 116 has a triangular prism shape and first and second inclined surfaces 112, 114. The two inclined surfaces 112, 114 meet each other at their elongated edges to form an elongated prism column.

In the conventional prism sheet, the inclined surfaces 112, 114 of the light concentrate unit 116 form a prism column with a peak edge having an angle of about 90°. In other words, the first and second inclined surfaces 112, 114 meet each other at their elongated edges at the right angle, so that paths of the light passing through the inclined surfaces 112, 114 can be adjusted toward a display panel (not shown).

FIG. 2 is a schematic cross-sectional diagram illustrating the paths of light traveling in a conventional prism sheet. In the conventional prism sheet 100, the light incident on the light incident surface 110 is transmitted through or reflected on the inclined surfaces 112, 114 of the light concentrate unit 116 depending on an angle between the direction of the incident light and the first or second inclined surfaces 112, 114.

For example, in case that the angle between the inclined surfaces 112, 114 at the peak edge of the light concentrate unit 116, or the “peak angle”, is about 90°, if light 140 is incident on the incident surface 110 at a light incidence angle of about 90°, then the incident light 140 passes through the light incident surface 110 and arrives at the first inclined surface 112 of the light concentrate unit 116. The light is then reflected on the first inclined surface 112 to the second inclined surface 114. The reflected light has a direction perpendicular to that of the incident light 140. The light arrived at the second inclined surface 114 is reflected again thereon toward the incident surface 110. The light reflected on the second inclined surface 114 has a direction perpendicular to that of the light reflected by the first inclined surface 112. The light reflected by the second inclined surface 114 exits the light incident surface 110. As a result, the light incident on the light incident surface 110 at the incidence angle of about 90° does not transmit the light concentrate unit 116, but is reflected back to the light incident surface 110.

In contrast, when the light concentrate unit 116 has the peak angle of about 90° and light 150 is incident on the light incident surface 110 at a light incidence angle which is not about 90° but inclined with respect to the light incident surface 110, the incident light 150 is refracted at the light incident surface 110 by a refraction index of the prism sheet and arrives at the first inclined surface 112 of the light concentrate unit 116. The light is refracted again at the first inclined surface 112 by the refraction index of the prism sheet and passes through the first inclined surface 112. As a result, when the light is incident on the light incident surface 110 at an incidence angle which is acute (i.e., less than 90°) with respect to the light incident surface 110, the incident light 150 is transmitted through the prism sheet 100 and concentrated toward a display device (not shown) disposed over the prism sheet 100.

In consideration of the above-described relationship between the reflection or transmission of the incident light and the light incidence angle, the prism sheet having the peak angle of about 90° has been used for a display device having a diffusion plate.

FIG. 3 is a schematic diagram illustrating a conventional LCD device employing the prism sheet 100 in FIGS. 1 and 2. The LCD device 200 includes a light source 210, a light guide plate 220, a diffusion plate 230, the prism sheet 110, and an LCD panel 250. Here, the light source 210 may be one or more lamps disposed at the sides 222 of the light guide plate 220. The LCD device 200 employing such light source 210 is referred to as an “edge illumination type.” This type of LCD device has advantages such as reducing the size, especially thickness, of the LCD device.

The light generated from the light source 210 is entered into the light guide plate 220 through its side surfaces 222 and guided to travel toward the diffusion plate 230. The light is then diffused by passing through the diffusion plate 230 and transmitted to the prism sheet 100, at which the light is concentrated as describe above. As a result, the light is provided to the LCD panel 250 in a direction perpendicular to the LCD panel. Here, the light emitted from the light guide plate 220 mostly has a light emission angle acute with respect to the light emission surface 224 of the light guide plate 220.

FIG. 4 shows luminance distribution on the diffusion plate 230 in FIG. 3. FIG. 5 is a graph illustrating luminance variation in FIG. 4 in association with different viewing angles. In FIGS. 4 and 5, the viewing angle varies from 90° to −90° (or 270°) and viewing angel 0° represents that a viewer watches the LCD device at a direction perpendicular to the LCD panel.

When light is emitted from the light guide plate 220, the light mostly has a light emission angle about 30° or −30° with respect to the direction perpendicular to the light emission surface 224 of the light guide plate 220 (referring to FIG. 3). Thus, regions L1 and L2 in the luminance distribution have maximum luminance “C” as shown in FIGS. 4 and 5. In other words, the regions on the diffusion plate corresponding to viewing angles 30° and −30° have maximum value “C” in its luminance distribution.

In contrast, lower luminance “D” is measured at the region corresponding to viewing angle 0° on the diffusion plate. In other words, as shown in FIG. 5, the luminance at front (i.e., viewing angle about 0°) is lower than the luminance at the regions L1 and L2 corresponding to viewing angles “A” and “B” (i.e., 30° and −30°), respectively. Such variation in the luminance distribution deteriorates the display quality of the LCD device.

To prevent the deterioration of the display quality due to the luminance variation, a diffusion plate is employed in the LCD device to improve the front luminance at viewing angle 0°. In addition, a prism sheet is disposed over the diffusion plate to further improve the front luminance of the LCD device. As described above, the prism sheet having about 90° of peak angle at the peak edge of each light concentrate unit improves the front luminance by refracting the light incident at an acute angle with respect to the surfaces of the light concentrate units.

FIG. 6 is a schematic diagram illustrating a direct illumination type of a conventional LCD device. As shown in FIG. 6, the direct illumination type LCD device 300 has multiple light sources 310, such as lamps, disposed parallel with each other under a diffusion plate 320. The light generated from the light sources 310 travels through the diffusion plate 320 and the prism sheet 100 toward an LCD panel 330.

Since the light sources 310 are disposed under the diffusion plate 320, the light passing through the diffusion plate 320 is mostly incident on the light incident surface 110 of the prism sheet 100 at an incidence angle of about 90° with respect to the light incident surface 110. The remaining portion of the light passing through the diffusion plate 320 is incident on the prism sheet 100 at an acute angle with respect to the light incident surface. In other words, compared with the edge illumination type LCD device where the light passing through the diffusion plate is mostly incident on the prism sheet at an acute angle with respect to the light incident surface (referring to FIG. 3), the light passing through the diffusion plate 320 in the direct illumination type LCD device is mostly incident on the prism sheet 100 at an incidence angle of about 90°.

Accordingly, in the direct illumination type LCD device 300, the light passing through the diffusion plate 320 is mostly reflected at the prism sheet 100. As described above, the light incident on the prism sheet 100 at the incidence angle perpendicular to the light incident surface 110 is reflected on the first inclined surface 112 toward the second inclined surface 114 at the right angle, and reflected again on the second inclined surface 114 toward the light incident surface 110 at the right angle. As a result, the light incident on the prism sheet at the right angle is reflected back to the light incident surface 110 of the prism sheet 100. The light exiting the diffusion plate 320 at the right angle is scattered away and lost by being reflected by the prism sheet. An experiment of the light illumination in the direct illumination type LCD device shows that large portion of the light generated from the light source 310 is reflected on the prism sheet 100 so as to be lost, and only small portion of the light is transmitted the prism sheet 100 toward the LCD panel 330.

Thus, employing the prism sheet 100 with the peak angel of about 90° in a direct illumination LCD device substantially decreases the luminance of the LCD device so that the display quality of the LCD device is substantially deteriorated.

FIG. 7 shows luminance distribution on the LCD panel in FIG. 6. FIG. 8 is a graph illustrating luminance variation in FIG. 7 in association with different viewing angles. When the viewing angle varies from 90° to −90° (or 270°), the luminance on the LCD panel varies as shown in FIG. 8. As mentioned above, since the light passing through the diffusion plate is mostly reflected on the prism sheet in case of the direct illumination type LCD device, the amount of light arriving at the LCD panel in the direct illumination type LCD device is much smaller than the amount of light arriving at the LCD panel in the edge illumination type LCD device. This is because a small amount of light incident on the prism sheet at an acute incidence angle is only transmitted through the prism sheet toward the LCD panel.

Also, the light incident on the light incident surface of the prism sheet at the incidence angle of about 90° exits the prism sheet approximately parallel with the light incident surface. The light exiting the prism sheet parallel with the light incident surface can hardly arrive on the LCD panel. The luminance of such light is shown in regions L3 and L4 in FIG. 7 and in regions F and G in FIG. 8. Thus, employing the prism sheet with the peak angle of about 90° causes such a light loss in the direct illumination type LCD device.

There have been developments to overcome such drawbacks in the conventional prism sheets. For example, one technology is that a prism sheet is fabricated to have a peak angle between the inclined surfaces of a concentrate unit in the range of selected angles. Such a prism sheet is disclosed in the U.S. Pat. No. 6,354,709 for Optical Film issued to Campbell et al., where a prism sheet is formed to have peak angle in the range from 70° to 110°. However, such prism sheet has little improvement on luminance distribution of an LCD device because the prism sheet has a fixed refraction index, such as 1.586, independent of variation of the peak angle. In other words, there would be little effect on improving the luminance distribution of an LCD device although the peak angle of the prism sheet is increased from 90° to 110°. This is because the optical characteristics of a prism sheet is determined by both the peak angle and the refraction index.

Therefore, a need exists for a prism sheet for enhancing luminance distribution at a display device by having a peak angle between the inclined surfaces of a light concentrate unit, which is selected from a certain range of degrees in association with the refraction index of the prism sheet.

### SUMMARY OF THE INVENTION

The above discussed and other drawbacks and deficiencies of the prior art are overcome or alleviated by a prism sheet and liquid crystal display device employing the same according to the present invention. In one embodiment, the prism sheet of the present invention includes a light incident surface for receiving the light, a light emission surface for emitting the light incident on the light incident surface, which includes at least one light concentrate unit having at least two inclined surfaces on which the light is incident and refracted. A peak angle between the two inclined surfaces is obtuse and determined in association with a refraction index of the prism sheet. Also, the light emission surface may have multiple light concentrate units that each have a shape of a prism column and are arranged parallel with each other in a longitudinal direction of the light concentrate units.

In another embodiment, the prism sheet of the present invention further includes a curved surface formed between the at least two inclined surfaces of each of the light concentrate units. When the light concentrate units each have a first width and the curved surface has a second width, a ratio of the second width to the first width is in a range from about 5% to about 20%.

In another embodiment, the prism sheet of the present invention further includes a base layer in which the light incident on the light incident surface travels toward the light emission surface. The base layer may be separately formed and attached onto the light emission surface such that the at least one light concentrate unit is disposed on the base layer.

The present invention also provides a liquid crystal display device that includes, as an exemplary embodiment, a lamp assembly for generating light, a diffusion plate for diffusing the light, the above-described prism sheet of the present invention; and a LCD panel assembly for displaying images using the light from the prism sheet and image data externally provided.

The present invention further provides a method of fabricating a prism sheet, which includes, as an exemplary embodiment, providing a base layer having a flat surface, disposing light refracting material on the flat surface of the base layer, in which the light refracting material has fluidity properties, leveling the light refracting material so that a layer of the light refracting material is formed on the flat surface of the base layer, transforming the layer of the light refracting material into a plurality of prism columns arranged parallel with each other on the base layer, and curing the plurality of prism columns to have solidity properties. The transforming step includes pressing the layer of the light refracting material with a pattern having the same shape as the prism columns, wherein the prism columns are formed to have a peak angle at a peak edge of the respective prism columns and the peak angle is in a range from about 91° to about 120°.

These and other objects, features and advantages of the present invention will become apparent from the following detailed description of the exemplary embodiments thereof, which is to be read in conjunction with the accompanying drawings, wherein like elements are designated by identical reference numbers throughout the several views.

### BRIEF DESCRIPTION OF THE DRAWINGS

This disclosure will present in detail the following description of exemplary embodiments with reference to the following figures wherein:

FIG. 1 is a perspective view of a conventional prism sheet;

FIG. 2 is a schematic cross-sectional diagram illustrating the paths of light traveling in a conventional prism sheet;

FIG. 3 is a schematic diagram illustrating a conventional LCD device employing the prism sheet in FIGS. 1 and 2;

FIG. 4 shows luminance distribution on the diffusion plate in FIG. 3;

FIG. 5 is a graph illustrating luminance variation in FIG. 4 in association with different viewing angles;

FIG. 6 is a schematic diagram illustrating a direct illumination type of a conventional LCD device;

FIG. 7 shows luminance distribution on the LCD panel in FIG. 6;

FIG. 8 is a graph illustrating luminance variation in FIG. 7 in association with different viewing angles;

FIG. 9 is a partially cut perspective view illustrating a prism sheet according to an exemplary embodiment of the present invention;

FIG. 10 is an enlarged view of portion “A” in FIG. 9;

FIG. 11 is a cross-sectional view of the prism sheet in FIG. 9;

FIG. 12 is an enlarged view of the light concentrate unit in FIG. 11;

FIG. 13 is a schematic cross-sectional view of a prism sheet according to another embodiment of the present invention;

FIG. 14 is a schematic cross-sectional view of a prism sheet according to another embodiment of the present invention;

FIGS. 15 and 16 illustrate an exemplary method of fabricating the prism sheet in FIG. 14;

FIG. 17 is a schematic diagram illustrating an LCD device according to an exemplary embodiment of the present invention; and

FIG. 18 is a graph illustrating luminance distribution at the LCD device in FIG. 17.

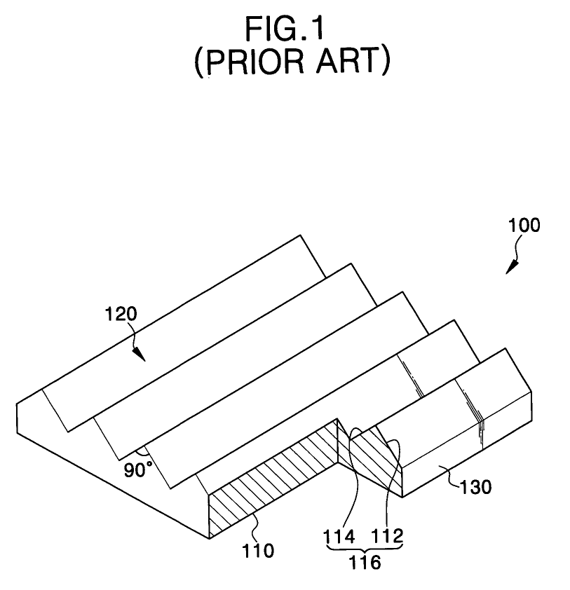

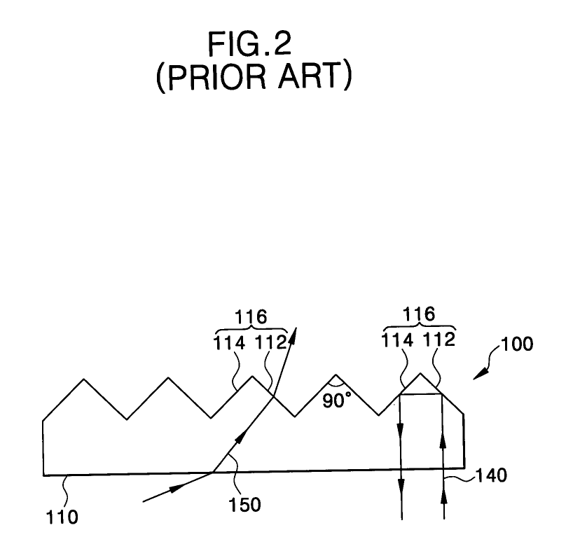

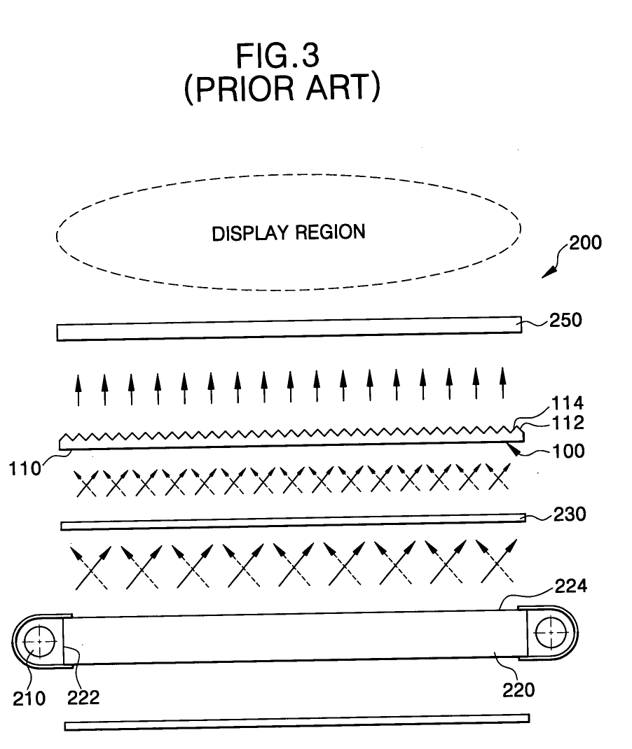

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention.

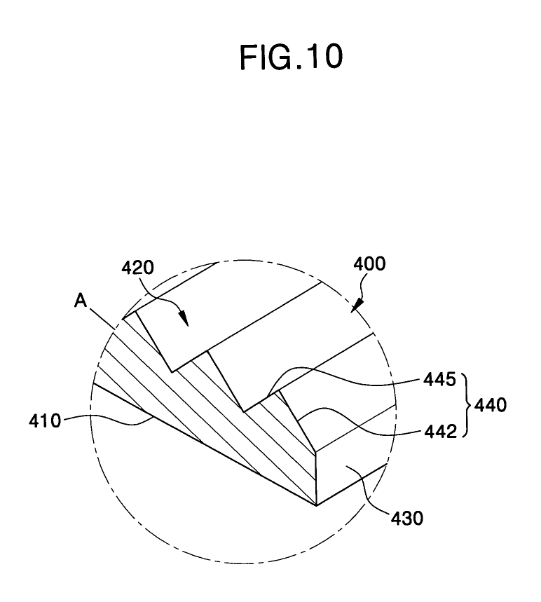

FIG. 9 is a partially cut perspective view illustrating a prism sheet according to an exemplary embodiment of the present invention. FIG. 10 is an enlarged view of portion “A” in FIG. 9. The prism sheet 400 includes a light incident surface 410, a light emission surface 420, and multiple side surfaces 430 connected with the light incident surface 410 and light emission surface 420 which are facing each other. Light generated from a light source (not shown) is incident on the light incident surface 410, which, for example, may be smooth. The incident light travels in the prism sheet 400 and exits the light emission surface 420.

The light emission surface 420 is formed with multiple light concentrate units 440 each having, for example, a prism column shape. Each of the light concentrate units 440 has first and second inclined surfaces 442, 445, which are elongated and aligned in a selected direction and meet each other at their longitudinal edges to form a peak edge of the light concentrate unit 440. The light concentrate units 440 are connected with each other such that the first inclined surface 442 of one light concentrate unit 440 is connected with the second inclined surface 445 of another adjacent light concentrate unit 440 at the longitudinal surfaces of the inclined surfaces.

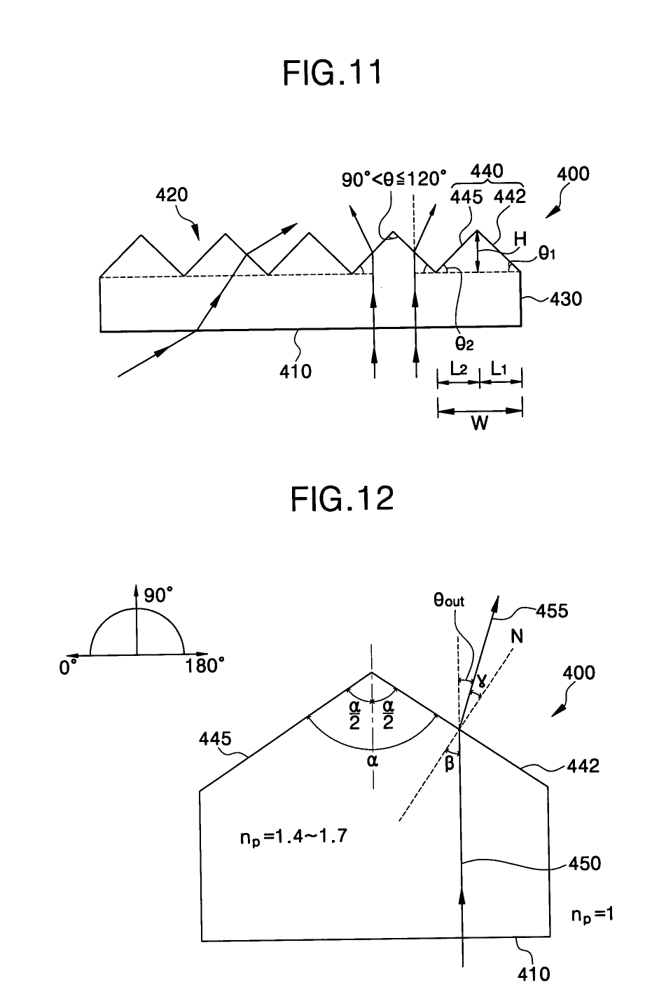

FIG. 11 is a cross-sectional view of the prism sheet in FIG. 9. As shown in FIG. 11, the first and second inclined surfaces 442, 445 of the light concentrate unit 440 are slant in an opposite direction with respect to each other. In other words, the first inclined surface 442 is inclined downward to the right from the peak edge 447, and the second inclined surface 445 is inclined downward to the left from the peak edge 447 of the light concentrate unit 440.

In particular, referring to FIG. 11, the light concentrate units 440 each have height H and width W so that the first and second inclined surfaces 442, 445 have the same height H and are configured in the first and second regions L1, L2, respectively. The regions L1 and L2 have a substantially identical length and constitute the width W of the light concentrate unit 440. The first and second inclined surfaces 442, 445 are inclined at first and second slant angles θ₁ and θ₂, respectively, with respect to the light incident surface. In this embodiment, the first and second slant angles θ₁ and θ₂ are identical to each other.

In the structure of the prism sheet 400, a first longitudinal edge of the first inclined surface 442 is in contact with the body of the prism sheet 400, and a second longitudinal edge of the first inclined surface 442, which is opposite to the first longitudinal edge, is in contact with a second longitudinal edge of the second inclined surface 445 at the peak edge of the light concentrate unit 440. A first longitudinal edge of the second inclined surface 445 is in contact with the body of the prism sheet 400. As a result, prism columns elongated and aligned in a selected direction are formed on the body of the prism sheet 400.

In this embodiment, the peak angle α of each light concentrate unit 440 is an obtuse angle larger than 90°. In other words, the prism sheet 400 is fabricated to have the peak angle α that is selected from the range, for example, from 91° to 120°. In addition, the prism sheet 400 is made of material having a refraction index in the range, for example, from about 1.40 to about 1.70. In determining values of the refraction index and the peak angle, one value is determined in association with the other. This relationship between the refraction index and peak angle is described in detail below.

FIG. 12 is an enlarged view of the light concentrate unit in FIG. 11. As shown in FIG. 12, the light 450 incident on the light incident surface 410 at the right angle is refracted on the first inclined surface 442 of the light concentrate unit 440 and exits the first inclined surface 442 at a light emission angle. A description of the relationship between the light emission angle and the peak angle α of the light concentrate unit follows.

In this embodiment, the prism sheet 400 is made of material having a refraction index in the range of from about 1.4 to about 1.7. For reference, the refraction index of air is “1.0”. Also, the light concentrate unit has the peak angle α between the first and second inclined surfaces 442, 445. When the light is incident on the first inclined surface 442 of the light concentrate unit, the light is incident in a direction having an incidence angle β with respect to the normal of the first inclined surface 442. When the incident light is refracted on the first inclined surface 442 and exits therethrough, the light exits in a direction having a refraction angle γ with respect to the normal of the first inclined surface 442. The light also exits at an emission angle θₒᵤₜ with respect to an imaginary vertical line perpendicular to the light incident surface 410.

When the light is incident and refracted on the first inclined surface 442 and exits therethrough, values of the incidence angle β, the refraction angle γ and the emission angle θₒᵤₜ may be obtained from the following equations.

$$\begin{matrix}β = 90 ° - \frac{α°}{2} & Equation 1 \\ γ = arcsin ( \frac{1}{{n}_{p}} \times sin β° ) & Equation 2 \\ {θ}_{out} = 90 ° - \frac{α°}{2} - γ° & Equation 3\end{matrix}$$

Here, “nₚ” represents a refraction index of the prism sheet.

As mentioned above, in this embodiment, the peak angle α is in the range from about 60° to about 140°, and the refraction index nₚ of the prism sheet is in the range from about 1.4 to about 1.7. Viewing angle and luminance of a display device employing the prism sheet of the present invention vary depending on the values of the refraction index and the peak angle. According to Equations 1 to 3, the incidence angle β is determined by values of the peak angle α and the refraction index nₚ, the refraction angle γ is then determined by the incidence angle β, and thus the emission angle θₒᵤₜ is determined by values of the refraction angle γ and the peak angle α. In other words, the emission angle θₒᵤₜ, which gives effect on the viewing angle and luminance, is determined depending on values of the peak angle α and the refraction index nₚ of the prism sheet. A detail description of the relationship between the emission angle θₒᵤₜ and values of the refraction index and the peak angle follows.

For the purpose of explaining the relationship between the peak angle and the refraction index, the applicable range of the refraction index is divided into three groups, first group in the range from about 1.41 to about 1.49, second group in the range from about 1.51 to about 1.59, and third group in the range from about 1.61 to about 1.69. The peak angle is selected in the range from about 60° to about 140° with respect to each of the three groups of the refraction index.

Referring to Table 1 below, angles β, γ and θₒᵤₜ are obtained from Equations 1 to 3 when the peak angle is selected in the range from 79° to 140° and the refraction index is in range of the first group. In Table 1, the value of the refraction index is set as “1.4” selected from the first group, while the value of the peak angle varies from 79° to 140°.

TABLE 1

| Peak | Incidence | Refraction | Emission |
|---|---|---|---|
| Angle α | Angle β | Angle γ | Angle θₒᵤₜ |
| (degrees) | (degrees) | (degrees) | (degrees) |
| 140° | 20° | 14.14° | 5.86° |
| 130° | 25° | 17.57° | 7.43° |
| 125° | 27.5° | 19.25° | 8.24° |
| 122° | 29° | 20.26° | 8.74° |
| 120° | 30° | 20.92° | 9.07° |
| 117° | 31.5° | 21.91° | 9.58° |
| 115° | 32.5° | 22.56° | 9.93° |
| 111° | 34.5° | 23.86° | 10.63° |
| 110° | 35° | 24.18° | 10.81° |
| 105° | 37.5° | 25.77° | 11.72° |
| 103° | 38.5° | 26.40° | 12.09° |
| 101° | 39.5° | 27.02° | 12.47° |
| 100° | 40° | 27.33° | 12.66 |
| 98° | 41° | 27.94° | 13.05 |
| 97° | 41.5° | 28.25° | 13.25 |
| 96° | 42° | 28.55 | 13.44 |
| 90° | 45° | 30.33 | 14.66 |
| 89° | 45.5° | 30.63 | 14.87 |
| 88° | 46° | 31.92 | 15.08 |
| 85° | 47.5° | 31.78 | 15.72 |
| 80° | 50° | 33.17 | 16.82 |
| 79° | 50.5° | 33.45 | 17.05 |

Given the values of the refraction index and the peak angle, the values of the incidence angle β may be obtained from Equation 1. Once a value of the incidence angle β is known, a corresponding value of the refraction angle γ may be obtained from Equation 2. With the value of the refraction angle γ known, a corresponding value of the emission angle θₒᵤₜ may be obtained from Equation 3.

For example, when the peak angle α is 110°, the incidence angle β is calculated as 35° from Equation 1 and thus the refraction angle γ is calculated as 24.18° from Equation 2 (here, nₚ=1.4). Accordingly, the emission angle θₒᵤₜ is calculated as 10.81° from Equation 3. In this embodiment, the closer is the emission angle θₒᵤₜ to zero, the more improved is the front luminance of the LCD device. In like manner, the front luminance of the LCD device decreases as the emission angle θₒᵤₜ increases.

In Table 1, it is shown that when the peak angle is smaller than 90° (or, from 60° to 90°), little light exits the prism sheet, and even if light exits the prism sheet, the front luminance and the viewing angle would be substantially deteriorated because the emission angle θₒᵤₜ increases considerably. When the peak angle is larger than 140°, the exiting light may cause an excessive decrease in the viewing angle of the LCD device although the luminance of the LCD device may be increased. Thus, the prism sheet having the peak angle larger than 140° is preferably used for an LCD device such that its luminance is more important than its viewing angle on its utilization purpose.. In contrast, when the peak angle α is in the range from 90° to 140° (more particularly, from 90° to 120°), the luminance and the viewing angle of the LCD display device are effectively improved.

Referring to Table 2 below, angles β, γ and θₒᵤₜ are obtained from Equations 1 to 3 when the peak angle α is in the range from 79° to 140° and the refraction index is selected from the range of the second group (i.e., from about 1.51 to about 1.59). In Table 2, the value of the refraction index is set as “1.5” selected from the second group, while the value of the peak angle α varies from 79° to 140°.

TABLE 2

| Peak | Incidence | Refraction | Emission |
|---|---|---|---|
| Angle α | Angle β | Angle γ | Angle θₒᵤₜ |
| (degrees) | (degrees) | (degrees) | (degrees) |
| 140° | 20° | 13.18° | 6.82° |
| 130° | 25° | 16.36° | 8.63° |
| 125° | 27.5° | 17.93° | 9.57° |
| 122° | 29° | 18.85° | 10.14° |
| 120° | 30° | 19.47° | 10.52° |
| 117° | 31.5° | 20.38° | 11.11° |
| 115° | 32.5° | 20.99° | 11.51° |
| 111° | 34.5° | 22.18° | 12.31° |
| 110° | 35° | 22.48° | 12.51° |
| 105° | 37.5° | 23.94° | 13.55° |
| 103° | 38.5° | 24.52° | 13.97° |
| 101° | 39.5° | 25.09° | 14.40° |
| 100° | 40° | 25.37° | 14.62° |
| 98° | 41° | 25.93° | 15.06° |
| 97° | 41.5° | 26.21° | 15.28° |
| 96° | 42° | 26.49° | 15.50° |
| 90° | 45° | 28.12° | 16.87° |
| 89° | 45.5° | 28.39° | 17.10° |
| 88° | 46° | 28.65° | 17.34° |
| 85° | 47.5° | 29.44° | 18.05° |
| 80° | 50° | 30.71° | 19.28° |
| 79° | 50.5° | 30.96° | 19.53° |

In like manner as obtaining the values in Table 1, given the values of the refraction index and the peak angle α, angles β, γ and θₒᵤₜ may be obtained from Equations 1, 2 and 3, respectively.

For example, when the peak angle α is 110°, the incidence angle β is calculated as 35° from Equation 1 and then the refraction angle γ is calculated as 22.48° from Equation 2 (here, nₚ=1.5). Using the values of the incidence and refraction angles β and γ, the emission angle θₒᵤₜ may be obtained as 12.52° from Equation 3 In this embodiment, the closer is the emission angle θₒᵤₜ to zero, the more improved is the front luminance of the LCD device. Also, the front luminance of the LCD device decreases as the emission angle θₒᵤₜ increases.

The emission angle θₒᵤₜ may be different depending on values of the refraction index as well as the peak angle of the prism sheet. For example, upon comparing the prism sheet with peak angle 110° and refraction index 1.4 in Table 1 with the prism sheet with the same peak angle 110° but different refraction index 1.5 in Table 2, the emission angle θₒᵤₜ in the prism sheet of Table 1 is 10.81° while the emission angle θₒᵤₜ in the prism sheet of Table 2 is 12.52°. The difference (0.1) in the values of the refraction index of the prism sheets in Tables 1 and 2 leads to the difference (1.71°) in the values of the emission angle θₒᵤₜ in the prism sheets in Tables 1 and 2. In other words, the luminance and the viewing angle of a display device may be changed by a slight change of the refraction index.

According to the data in Table 2, when the peak angle α is smaller than 90°, little light exits the prism sheet; when the peak angle α is in the range from 90° to 140°, the exiting light improves the luminance and the viewing angle of a display device; and when the peak angle α is larger than 140°, the exiting light may cause an excessive decrease in the viewing angle although the luminance may be increased. In particular, when the peak angle α is in the range from 90° to 120°, the luminance and the viewing angle are effectively improved.

Referring to Table 3 below, the incidence angle β, the refraction angle γ, and the emission angle θₒᵤₜ are obtained from Equations 1, 2 and 3, respectively, when the peak angle α is in the range from 79° to 140° and the refraction index is selected from range of the third group (i.e., from about 1.61 to about 1.69). In this example, the value of the refraction index is set as “1.6” selected from the second group, while the value of the peak angle α varies from 79° to 140°.

TABLE 3

| Peak | Incidence | Refraction | Emission |
|---|---|---|---|
| Angle α | Angle β | Angle γ | Angle θₒᵤₜ |
| (degrees) | (degrees) | (degrees) | (degrees) |
| 140° | 20° | 6.82° | 12.34° |
| 130° | 25° | 8.63° | 15.13° |
| 125° | 27.5° | 9.57° | 16.77° |
| 122° | 29° | 10.14° | 17.63° |
| 120° | 30° | 10.52° | 18.21° |
| 117° | 31.5° | 11.11° | 19.06° |
| 115° | 32.5° | 11.51° | 19.62° |
| 111° | 34.5° | 12.31° | 20.73° |
| 110° | 35° | 12.51° | 21.00° |
| 105° | 37.5° | 13.55° | 22.36° |
| 103° | 38.5° | 13.97° | 22.89 |
| 101° | 39.5° | 14.40° | 23.42 |
| 100° | 40° | 14.62° | 23.68 |
| 98° | 41° | 15.06° | 24.20 |
| 97° | 41.5° | 15.28° | 24.46 |
| 96° | 42° | 15.50° | 24.72 |
| 90° | 45° | 16.87° | 26.23 |
| 89° | 45.5° | 17.10° | 26.47 |
| 88° | 46° | 17.34° | 26.71 |
| 85° | 47.5° | 18.05° | 27.44 |
| 80° | 50° | 19.28° | 28.60 |
| 79° | 50.5° | 19.53° | 28.83 |

In the like manner as obtaining the values in Tables 1 and 2, given the values of the refraction index and the peak angle α, the incidence angle β, the refraction angle γ and the emission angle θₒᵤₜ may be obtained from Equations 1, 2 and 3, respectively.

For example, when the peak angle α is 110°, the incidence angle β is calculated as 35° from Equation 1, and then the refraction angle γ is calculated as 21° from Equation 2 (here, nₚ=1.5). Using the values of the incidence and refraction angles β and γ, the emission angle θₒᵤₜ may be obtained as 14° from Equation 3. As the emission angle θₒᵤₜ is closer to zero, the front luminance is more improved. Also, the front luminance decreases as the emission angle θₒᵤₜ increases.

By comparing the prism sheet with peak angle 110° and refraction index 1.4 in Table 1 with the prism sheet with the same peak angle 110° but different refraction index 1.6 in Table 3, it is shown that the emission angle θₒᵤₜ in the prism sheet of Table 1 is 10.81° while the emission angle θₒᵤₜ in the prism sheet of Table 3 is 14°. The difference (0.2) in the values of the refraction index of the prism sheets in Tables 1 and 3 leads to the difference (3.19°) in the values of the emission angle θₒᵤₜ in the prism sheets in Tables 1 and 3. Thus, the emission angle θₒᵤₜ is different depending on values of the refraction index of the prism sheet even when the peak angle has the same value. Accordingly, the luminance and the viewing angle of a display device can be changed by changing the peak angle, the refraction index, or the combination thereof.

According to the data in Table 3, when the peak angle α is in the range from 60° to 90°, it is difficult for light to exit the prism sheet; when the peak angle α is in the range from 90° and 140° (particularly, from 90° to 120°), the exiting light improves the luminance and the viewing angle of the display device; and when the peak angle α is larger than 140°, the viewing angle considerably decreases although the luminance increases.

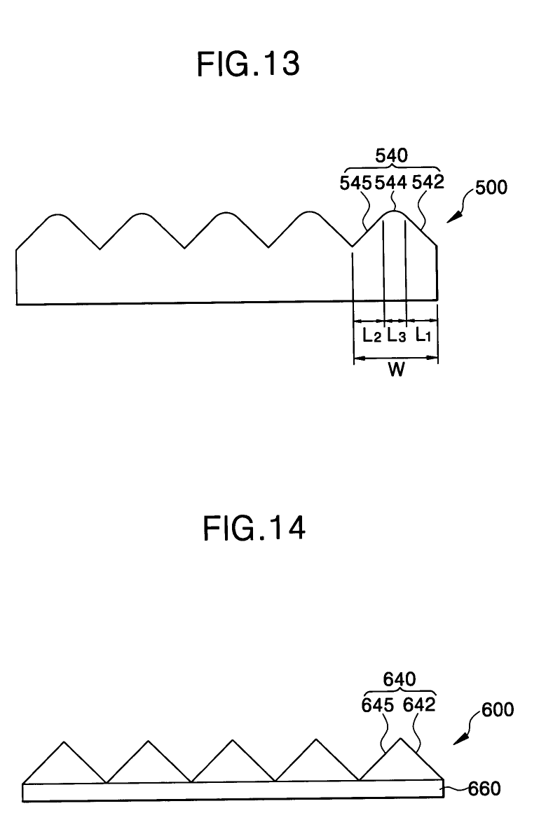

FIG. 13 is a schematic cross-sectional view of a prism sheet according to another embodiment of the present invention. The prism sheet 500 has a light emission surface formed with multiple light concentrate units 540. Compared with the prism sheet 400 shown in FIG. 11, the light concentrate units 540 of the prism sheet 500 in FIG. 13 each have a curved surface 544 at the peak edge between the first and second inclined surfaces 542, 545. In this embodiment, when the light concentrate unit 540 has width w, the first and second inclined surfaces 542, 545 and the curved surface 544 are formed at three regions 11, 12 and 13, respectively, which constitute width w. The lengths of l₁, l₂ and l₃ are corresponding to those of lines of the first and second light concentrate surfaces 542, 545 and the curved surface 544 that are projected onto a horizontal plane parallel with the light incident surface 510 of the prism sheet 500. The curved surface 544 may be formed between the first and second light concentrate surfaces 542, 545 in such a way that length l₃ is about 5% to 20% of the width w of the light concentrate unit 540.

FIG. 14 is a schematic cross-sectional view of a prism sheet according to another embodiment of the present invention. In this embodiment, the prism sheet 600 has a base film 660 and multiple light concentrate units 640 on the base film. The bottom surface of the base film, which is facing the surface on which the light concentrate units 640 are formed, is a light incident surface 610 onto which the light is provided from an external light source. The light concentrate units 640 in FIG. 14 constitute a light emission surface of the prism sheet 600 and may have, for example, one of the shapes shown FIGS. 11 and 13.

Since the light concentrate units 640 and the base film 660 are separately formed, they may be made of different material having different refraction indexes or the same refraction index. For example, the light concentrate units 640 are made of material having a refraction index in the range from about 1.40 to about 1.70, and the base film 660 is made of transparent material having a similar refraction index. The prism sheet may be made of, for example, polycarbonate, polyester, polyethyleneterphthalate, or the combination thereof.

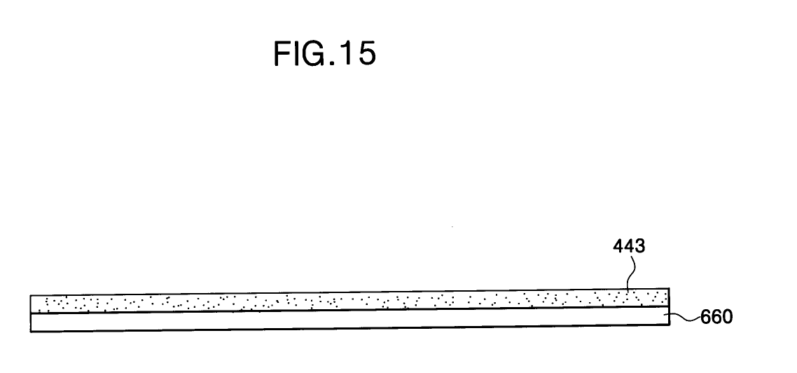

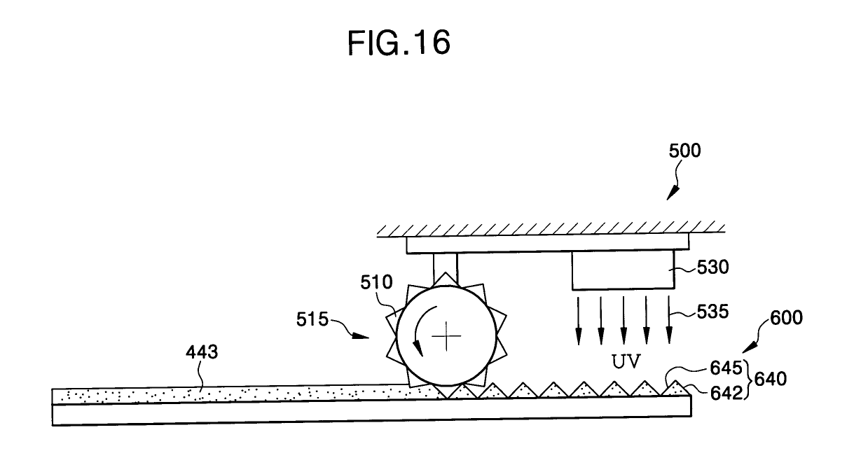

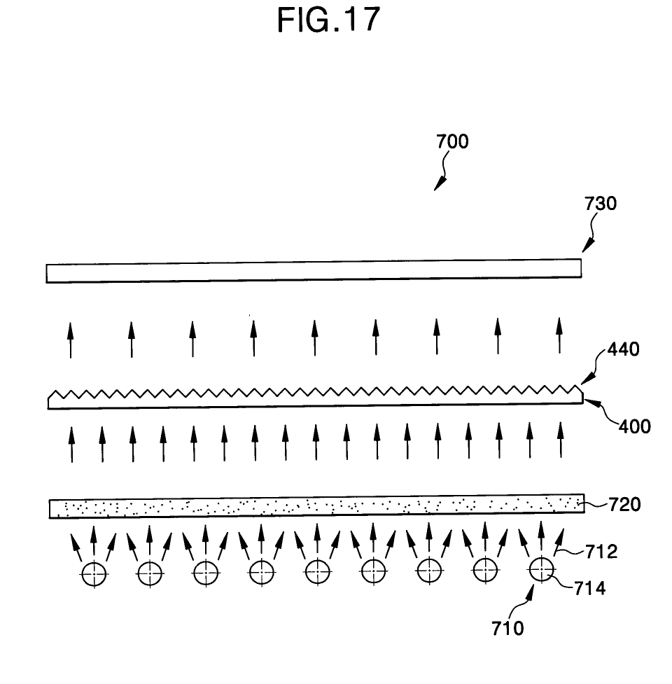

An exemplary method of fabricating the prism sheet in FIG. 14 is illustrated in FIGS. 15 and 16. Referring to FIG. 15, the base film 660 is first prepared in the shape of a flat plate. The base film 660 may have the same size as that of the prism sheet. Upon preparing the base film 660, a light refracting material 443 is deposited on the surface of the base film 660. The light refracting material 443 is leveled to form a thin layer of the light refracting material 443 on the base film 660. The light refracting material 443 includes a conditionally indurative material that can be cured when certain conditions are met. For example, the light refracting material 443 may be UV (ultraviolet) curable material that becomes cured by being subjected to UV beam.

The light refracting material 443 also has fluidity enough to be spread uniformly over the entire surface of the base film 660 and maintains fluidity until being subjected to UV beam. The light refracting material 443 includes, for example, polycarbonate, polyester, polyethyleneterphthalate, or the combination thereof. The refraction index of the light refracting material 443 is in the range from about 1.4 to about 1.7.

Upon depositing the light refracting material 443 on the base film 660, a pattern forming device 500 is disposed on the light refracting material 443 to form a predetermined pattern thereon, as shown in FIG. 16. The pattern forming device 500 has a roller 515 with the predetermined pattern 510 on its surface. In this embodiment, the predetermined pattern 510 may be a pattern of prism columns each having a cross-sectional view of a sawtooth shape. In this case, the grooved columns between the prism columns of the pattern 510 on the roller 515 are corresponding to the prism columns (i.e., the light concentrate units) 640 of the prism sheet 600. In other words, the inclined surfaces of a grooved column has the same shape as that of the inclined surfaces 642, 645 of a corresponding prism column (i.e., light concentrate unit) 640.

The pattern forming device 500 also has a UV radiator 530 for generation UV beam 535 that is used for curing the light refracting material 443. As the roller 515 rotates to proceed forward, the prism pattern 510 on the roller 515 forms the prism pattern on the light refracting material 443. Since the light refracting material 443 has fluidity, the prism columns on the roller 515 form the light concentrate units 640 by pressing the light refracting material 443 with the roller 515. It should be noted that the light refracting material 443 has fluidity to the extent that it may be transformed into the multiple prism columns by being pressed with the prism pattern 510 on the roller 515, but not be transformed once having the prism column shape.

Upon forming the prism columns of the light refracting material on the base film, the UV radiator 530 provides UV bean 535 over the prism columns to cure the light refracting material. The prism columns of the light refracting material become the light concentrate units 640 by being subjected to the UV beam enough to have solidity. In this embodiment, it should be noted that the prism pattern 510 on the roller 515 is designed to have an obtuse angle between the inclined surfaces of each of the grooved columns, so that the peak angle of each of the light concentrate units 640 is obtuse. For example, the light concentrate units 640 each have a peak angle in the range from 90° to 120°.

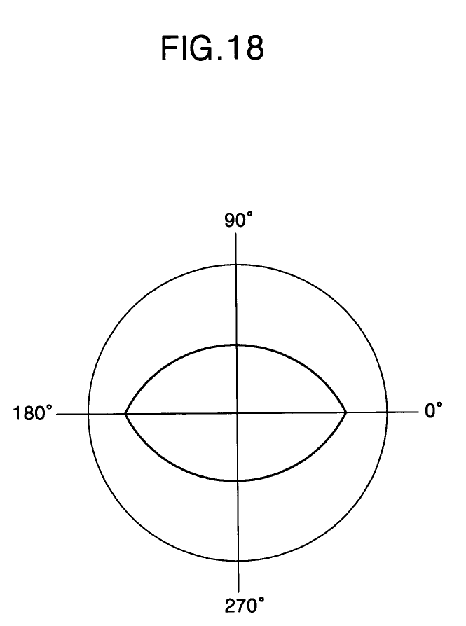

FIG. 17 is a schematic diagram illustrating an LCD device according to an exemplary embodiment of the present invention. The LCD device 700 includes a lamp assembly 710, a diffusion plate 720, a prism sheet 400, and an LCD panel assembly 730. In this embodiment, the LCD device 700 employs the prism sheet 400 that is the same type as one shown in FIGS. 9-12. It should be noted that the LCD device 700 may employ other types of prism sheet, such as the prism sheets described above referring to FIGS. 13 and 14.

The lamp assembly 710 has one or more lamps 714 for generating light 712. In case that the multiple lamps 714 are installed in the lamp assembly 710, the lamps 714 are arranged parallel with each other and adjacent lamps are apart from each other at a regular distance. Since the lamps 714 are spaced to each other, the luminance of the light generated from the lamp assembly 710 does not have uniform distribution. In other words, the luminance on the lamp assembly 710 may have variation such that the luminance measured near each lamp 714 is relatively high and the luminance measured near the space between adjacent lamps 714 is relatively low.

The diffusing plate 720 is disposed over the lamp assembly 710 to diffuse the light 712 provided from the lamp assembly 710. By being diffused in the diffusing plate 720, the light 712 from the lamp assembly 710 exits the diffusion plate 720 having uniform luminance distribution. In other words, the luminance measured on the diffusion plate 720 has relatively uniform distribution. In addition to diffusing the light, the diffusion plate 720 adjusts paths of the incident light so that the light exiting the diffusion plate 720 has a direction approximately vertical to the diffusion plate 720.

The prism sheet 400 is disposed over the diffusion plate 720 to concentrate the light provided from the diffusion plate 720. The prism sheet 400 has the light concentrate units 440 each having the inclined surfaces. The light incident on the prism sheet 400 is refracted on the inclined surfaces to exit the prism sheet 400. The light exiting the diffusion plate 720 in a direction approximately vertical to the surface of the diffusion plate 720, so that the light incident onto the prism sheet 400 also has a direction approximately vertical to the light incident surface of the prism sheet 400. In this embodiment, the light concentrate units 440 each have a peak angle that is obtuse, for example, in the range from 90° to 140°. Thus, the light incident on the inclined surfaces of the respective light concentrate units 440 is refracted to be concentrated toward the LCD panel assembly 730. Since the prism sheet 400 is described above in detail with reference to FIGS. 9-12, a further detail description of the prism sheet will be omitted to avoid description duplication.

The LCD panel assembly 730 displays images using the light from the prism sheet 400 as well as processing image data externally provided. Since the light is concentrated by the prism sheet 400, the light is incident on the LCD panel assembly 730 at an incidence angle approximately perpendicular to the LCD panel assembly 730. Accordingly, the luminance and the viewing angle at the LCD panel assembly 730 is improved, so that the LCD panel assembly 730 displays quality images.

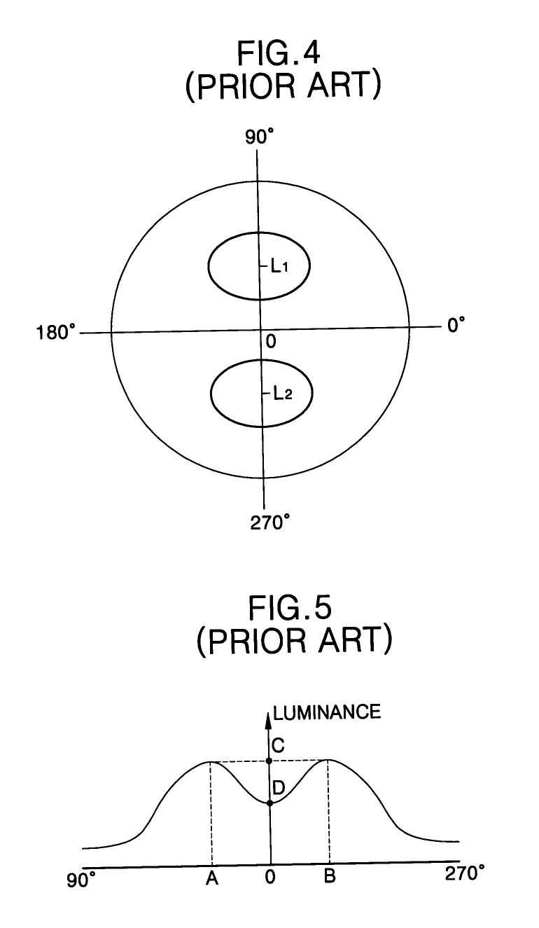

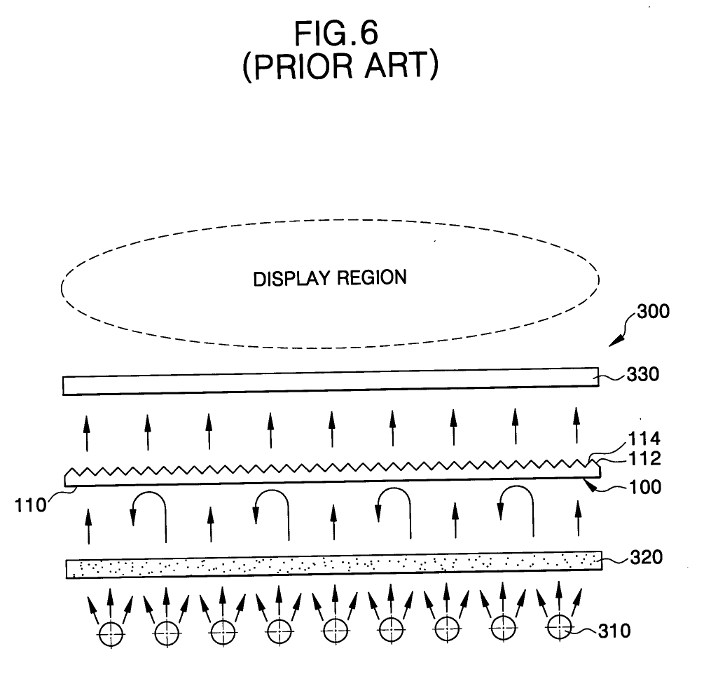

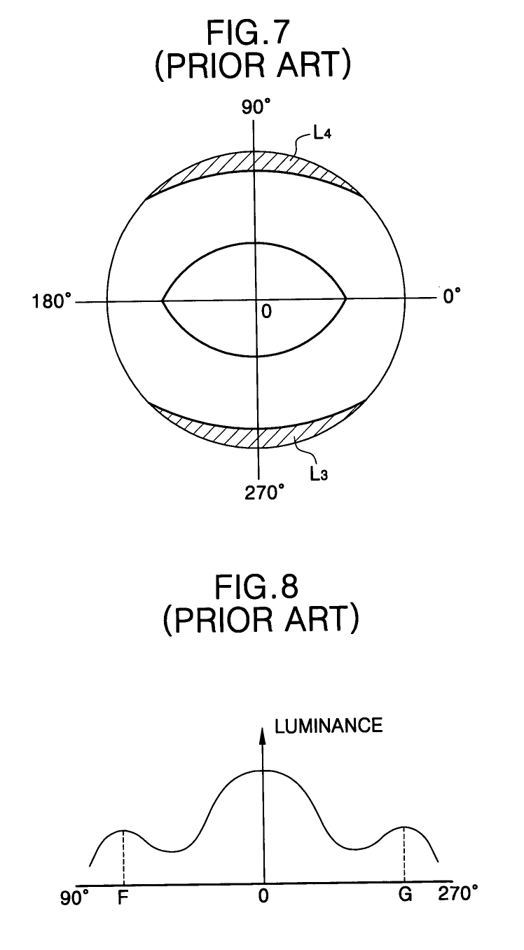

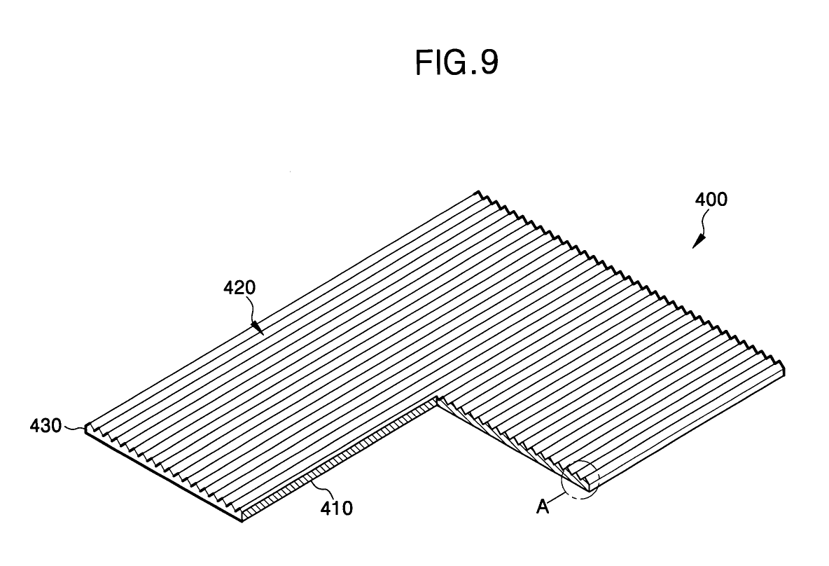

FIG. 18 is a graph illustrating luminance distribution at the LCD device in FIG. 17. The luminance distribution at the LCD device varies depending on values of the viewing angle as shown in FIG. 18. Compared with the graphs illustrating the luminance distribution at a conventional LCD device in FIGS. 4 and 7, the luminance distribution at the LCD device according to the present invention is improved at the front and side viewing angles. For example, the luminance is maximized at the front viewing angle, and there is no loss of light at the side viewing angles.

Accordingly, in the LCD device of the present invention, the luminance and the viewing angle are improved by employing the prism sheet having a refraction index and an obtuse peak angle that are appropriate to maximize the luminance distribution at the LCD device. The appropriate refraction index and peak edge are determined through the experimental simulation as described above with reference to Tables 1-3.

While the invention has been described with reference to the exemplary embodiments, it will be understood by those skilled in the art that various changes may be made and equivalents may be substituted for elements thereof without departing form the scope of the invention. In addition, many modifications may be made to adapt a particular situation or material to the teachings of the invention without departing from the essential scope thereof. Therefore, it is intended that the invention may not be limited to the particular embodiments disclosed as the best mode contemplated for carrying out this invention, but that the invention will include all embodiments falling within the scope of the intended claims.

What is claimed is:

1. A prism sheet for adjusting paths of light externally provided, comprising:
a light incident surface for receiving the light; and
a light emission surface for emitting the light incident on the light incident surface, wherein the light emission surface includes at least one light concentrate unit which has at least two inclined surfaces on which the light is incident and refracted, and a peak angle between the two inclined surfaces is obtuse and determined in association with a refraction index of the prism sheet.

2. The prism sheet of claim 1, wherein the light emission surface includes a plurality of the light concentrate units each having the at least two inclined surfaces and the peak angle.

3. The prism sheet of claim 2, wherein the light concentrate units each have a shape of a prism column and are arranged parallel with each other in a longitudinal direction of the light concentrate units.

4. The prism sheet of claim 1, wherein one of the two inclined surfaces forms a first angle with respect to the light incident surface and the other of the two inclined surfaces forms a second angle with respect to the light incident surface, the first and second angles are equal to each other.

5. The prism sheet of claim 1, wherein the peak angle between the two inclined surfaces is in a range form about 90° to about 140°.

6. The prism sheet of claim 5, wherein the refraction index of the prism sheet is in a range from about 1.4 to about 1.7.

7. The prism sheet of claim 6, wherein the peak angle is in a range from about 90° to about 120°, and the refraction index of the prism sheet is in a range from about 1.41 to about 1.49.

8. The prism sheet of claim 6, wherein the peak angle is in a range from about 90° to about 120°, and the refraction index of the prism sheet is in a range from about 1.51 to about 1.59.

9. The prism sheet of claim 6, wherein the peak angle is in a range from about 90° to about 120°, and the refraction index of the prism sheet is in a range from about 1.61 to about 1.69.

10. The prism sheet of claim 6, wherein the light exits the inclined surfaces at a light emission angle with respect to an imaginary line perpendicular to the light incident surface, and the inclined surfaces are configured such that the light emission angle is in a range from about 5.86° to about 26.23°.

11. The prism sheet of claim 10, wherein the inclined surfaces are configured such that light incident on one of the inclined surfaces travels in accordance with the following conditions of Equations 1 to 3:
$$\begin{matrix}β = 90 ° - \frac{α°}{2} & Equation 1 \\ γ = arcsin ( \frac{1}{{n}_{p}} \times sin β° ) & Equation 2 \\ {θ}_{out} = 90 ° - \frac{α°}{2} - γ° & Equation 3\end{matrix}$$
where, “α” represents the peak angle, “β” represents an incidence angle between a light incident direction and a normal of the one of the inclined surfaces, “γ” represents the refraction angle, “θₒᵤₜ” represents the emission angle, and “nₚ” represents the refraction index.

12. The prism sheet of claim 6, further including a curved surface formed between the at least two inclined surfaces of each of the light concentrate units.

13. The prism sheet of claim 12, wherein the light concentrate units each have a first width and the curved surface has a second width, a ratio of the second width to the first width is in a range from about 5% to about 20%.

14. The prism sheet of claim 6, further including a body in which the light incident on the light incident surface travels toward the light emission surface, wherein the body integrally formed with the light incident surface and the light emission surface.

15. The prism sheet of claim 6, further including a base layer in which the light incident on the light incident surface travels toward the light emission surface, wherein the base layer is separately formed and attached onto the light emission surface such that the at least one light concentrate unit is disposed on the base layer.

16. The prism sheet of claim 6, wherein the light concentrate units are made of material including polycarbonate, polyester, polyethyleneterphthalate, or a combination thereof.

17. The prism sheet of claim 6, wherein the peak angle is in a range from about 110° to about 140°, and the refraction index varies in proportional to a value of the peak angle.

18. A liquid crystal display device comprising:
a lamp assembly for generating light;
a diffusion plate for diffusing the light;
a prism sheet for adjusting paths of the light, the prism sheet including:
a light incident surface for receiving the light; and
a light emission surface for emitting the light incident on the light incident surface, wherein the light emission surface includes at least one light concentrate unit which has at least two inclined surfaces on which the light is incident and refracted, and a peak angle between the two inclined surfaces is obtuse and determined in association with a refraction index of the prism sheet; and
a LCD panel assembly for displaying images using the light from the prism sheet and image data externally provided.

19. The liquid crystal display device of claim 18, wherein the light emission surface includes a plurality of the light concentrate units each having the at least two inclined surfaces and the peak angle, and the light concentrate units each have a shape of prism column and are arranged parallel with each other in a longitudinal direction of the light concentrate units.

20. The liquid crystal display device of claim 18, wherein the peak angle between the two inclined surfaces is in a range form about 90° to about 140°, and the refraction index of the prism sheet is in a range from about 1.4 to about 1.7.

21. The liquid crystal display device of claim 20, wherein the lamp assembly has a plurality of lamps arranged parallel with each other in a selected direction, the lamps being disposed at a side of the diffusion plate opposite to a side at which the prism sheet is disposed.

22. A method of fabricating a prism sheet for adjusting a light path, comprising:
providing a base layer having a flat surface;
disposing light refracting material on the flat surface of the base layer, the light refracting material having fluidity properties;
leveling the light refracting material so that a layer of the light refracting material is formed on the flat surface of the base layer;
transforming the layer of the light refracting material into a plurality of prism columns arranged parallel with each other on the base layer; and
curing the plurality of prism columns to have solidity properties.

23. The method of claim 22, wherein the transforming includes pressing the layer of the light refracting material with a pattern having the same shape as the prism columns, wherein the prism columns are formed to have a peak angle at a peak edge of the respective prism columns and the peak angle is in a range from about 90° to about 140°.

24. The method of claim 23, wherein the prism columns with solid properties have a refraction index in a range from about 1.4 to about 1.7.

25. The method of claim 24, wherein the peak angle varies in proportional to a refraction index of the light refracting material.
